(19) United States
(12) Patent Application Publication
(10) Pub. No.: US 2007/0291413 A1
(43) Pub. Date: Dec. 20, 2007

(54) Disk Cartridge

(75) Inventors: Hiroya Kondou, Okayama (JP); Nobuo Akahira, Kyoto (JP)

Correspondence Address: MARK D. SARALINO (MEI);RENNER, OTTO, BOISSELLE & SKLAR, LLP, 1621 EUCLID AVENUE, 19TH FLOOR, CLEVELAND, OH, 44115, US

(73) Assignee: MATSUSHITA ELECTRIC INDUSTRIAL CO., LTD., Kadoma-shi (JP)

(21) Appl. No.: 11/576,006

(22) PCT Filed: Sep. 27, 2005
(86) PCT No.: PCT/JP05/17740

§ 371 Date: Mar. 26, 2007

(30) Foreign Application Priority Data
Sep. 28, 2004 (JP) 2004-281832
Oct. 21, 2004 (JP) 2004-306655

(51) Int. Cl. G11B 23/03

(52) U.S. Cl. 360/133

(57) ABSTRACT

A disk cartridge includes a cartridge body and a lid. The cartridge body includes: first and second principal surfaces opposed to each other; a storage space to store a disklike data storage medium; windows cut through the first and second principal surfaces to partially expose the data storage medium in the storage space; an opening for removing the data storage medium from the storage space; and write-protect indicator holes cut through the first and second principal surfaces to prohibit writing on the data storage medium stored. The lid is provided to cover and uncover the opening of the cartridge body. The cartridge body is shaped such that both of the first and second principal surfaces can be opposed to a pickup of an optical disk drive when the cartridge is loaded into the drive. Of the two write-protect indicator holes of the first and second principal surfaces, only the hole of the second principal surface is provided with a write enable/disable selecting mechanism that covers or uncovers the write-protect indicator hole.

### TECHNICAL FIELD

The present invention relates to a disk cartridge to store a disklike data storage medium.

### BACKGROUND ART

Disklike data storage media for optically reading and writing data (which will be referred to herein as “optical disks”) are used extensively nowadays as media to store a huge amount of digital data. The optical disks are classifiable into read-only ones and recordable ones. The recordable optical disks are further grouped into optical disks on which data can be written only once (and which are called “write-once disks”) and rewritable optical disks on which data can be written a number of times. In the following description, a rewritable optical disk will be taken as an exemplary recordable optical disk.

In rewriting data on a rewritable optical disk, if the surface of the data (recordable) side of the optical disk is soiled with dust or finger marks, the data may not be written properly there. For that reason, rewritable optical disks are often stored in a disk cartridge so as to prevent the surface of the data side from being soiled with dust or finger marks.

Meanwhile, as read-only optical disks are not stored in a cartridge, an optical disk drive dedicated to read-only optical disks cannot play any rewritable optical disk that is stored in a cartridge. That is why there is a growing demand for getting a rewritable optical disk played by such an optical disk drive dedicated to read-only optical disks. To meet such a demand, disk cartridges, from which the disk is removable, have been proposed.

Patent Document No. 1 discloses a conventional disk cartridge from which a disk is removable. As shown in FIG. 7, the conventional disk cartridge 101 includes a cartridge body 103, a lid 104, and a shutter 106.

The cartridge body 103 has a thin hexahedron shape with a space for storing a rewritable optical disk 102. The two opposed principal surfaces of the hexahedron cartridge body 103 have windows 105 that partially expose the optical disk 102. The shutter 106 moves parallel to the two principal surfaces so as to open or close the windows 105. When the cartridge 101 is loaded into an optical disk drive, an opener provided for the optical disk drive gets interlocked with the shutter 105. And as the cartridge 101 goes deeper into the drive, the shutter 106 moves so as to open the windows 105.

The cartridge body 103 has an opening 107 to remove the disk 102. The opening 107 is one of the six sides of the hexahedron. The lid 104 is attached to the cartridge body 103 at one end thereof so as to be rotatable on a shaft 108, which is arranged near the opening 107 of the cartridge body 103.

An engaging portion 109 is provided at the other end of the lid 104. When the engaging portion 109 gets engaged with the engaging portion 110 of the cartridge body 103, the opening 107 can be kept covered with the lid 104.

A tab portion 111 is provided for the cartridge body 103 near the engaging portion 109. FIG. 8 illustrates the tab portion 111 of the cartridge body 103 on a larger scale. The tab portion 111 is connected to the cartridge body 103 at multiple points with connecting portions 112 and is fitted into a groove portion 113 of the lid 104. That is why when used normally, the lid 104 cannot be rotated unless the tab portion 111 is disconnected from the cartridge body 103 by cutting off the connecting portions 112. That is to say, the optical disk 102 cannot be removed unless the tab portion 111 is cut off.

The lid 104 also has a write-protect indicator hole 114 and a movable member 115 that can open and close the write-protect indicator hole 114. The optical disk drive to be loaded with the disk cartridge 101 sees if the write-protect indicator hole 114 is open and may or may not perform a write operation on the optical disk 102 in the disk cartridge 101 depending on whether the hole 114 is opened or closed. For example, if the movable member 115 closes the write-protect indicator hole 114, writing on the optical disk 102 is permitted. On the other hand, unless the write-protect indicator hole 114 is closed with the movable member 115, writing on the optical disk 102 is prohibited. The movable member 115 may be moved by the user. That is to say, the user can determine whether writing on the optical disk 102 is permitted or prohibited.

Next, it will be described with reference to FIGS. 9A through 9C how to remove the optical disk 102. As shown in FIG. 9A, if the optical disk 102 has never been removed from the disk cartridge 101, the tab portion 111 is still connected to the disk cartridge 101. However, once the tab portion 111 is removed by cutting off the connecting portions 112 shown in FIG. 9A, the disk cartridge 101 looks as shown in FIG. 9B. Since the tab portion 111 has been removed, the tab portion 111 is now disengaged from the groove portion 113 of the lid 104. In this situation, the opening 107 can be uncovered by turning the lid 104 on the shaft 108. As a result, the optical disk 102 can be removed as shown in FIG. 9C.

Once the optical disk 102 has been removed, the disk cartridge 101 no longer has the tab portion 111. That is why the user can see easily whether the disk 102 stored has ever been removed or not. Also, by sensing whether the tab portion 111 is still attached or not, the optical disk drive can choose an appropriate method of writing to the disk. For example, suppose that once removed from the disk cartridge 101, the optical disk 102 will get soiled with finger marks or dust to the point that the writing to the disk 102 should be affected. On this supposition, if the tab portion 111 is still attached to the disk cartridge, then the optical disk 102 has never been removed from the disk cartridge 101. In that case, there is a little chance that the optical disk 102 has got soiled with finger marks or dust and writing should be done properly on the optical disk 102. On the other hand, if the tab portion 111 is no longer attached to the disk cartridge 101, the optical disk 102 has been removed from the disk cartridge 101 at least once. For that reason, chances are the optical disk 102 has got soiled with finger marks or dust and writing could not be done properly on the optical disk 102. In that case, even if the write-protect indicator hole 114 shows that writing is permitted, writing on such a disk may still be prohibited or not permitted until the disk has been checked for any defects.

Disk cartridges with such a structure have been adopted to store a DVD disk and have been used more and more extensively as DVD recorders have become increasingly popular. According to the technique disclosed in Patent Document No. 1 mentioned above, a DVD-RAM disk, which is one of the most popular types of DVDs today, can be removed from its disk cartridge. It is also possible to sense that the optical disk 102 should have been removed from the disk cartridge 101. And if the optical disk drive prohibits writing or checks the DVD-RAM disk for any defects based on the result of sensing, data can be written on the DVD-RAM disk with good reliability.

The DVD-RAM disks available now include DVD-RAM disks with dual data storage layers and DVD-RAM disks with a single data storage layer. That is why two types of disk cartridges have been used for these two types of disks. Hereinafter, conventional disk cartridges for DVD-RAMs will be further described.

FIGS. 10A and 10B illustrate a disk cartridge 21 to store an optical disk 200 with a single data storage layer. As shown in FIG. 10A, the disk cartridge 21 includes a cartridge body 22, a shutter 25, and a lid 24. The cartridge body 22 includes a pair of opposed principal surfaces 22a, 22b, a pair of side surfaces 23a, 23b that defines the gap between the principal surfaces 22a, 22b, and another side surface 23c interposed between the side surfaces 23a, 23b. The principal surfaces 22a, 22b and the side surfaces 23a, 23b and 23c define the six sides of a parallel hexahedron. The cartridge body 22 has an opening 23d that is opposed to the side surface 23c. A shaft 23a is arranged near the opening 23d and side surface 23b of the cartridge body 22 and the lid 24 is attached so as to rotate on the shaft 23a.

The principal surfaces 22a, 22b have windows 29 that partially expose the optical disk 102. The shutter 25 includes a pair of main portions to close the windows 29 of the principal surfaces 22a, 22b and a connecting portion to connect the two main portions together. By sliding the connecting portion along the side surface 23c, the main portions open or close the windows 29.

The side surfaces 23a, 23b have recessed gripper slots 26a, 26b near the opening 23d and also have V-groove auto-loading detents 27a, 27b near the side surface 23c. The gripper slots 26a, 26b fit the protrusions of the optical disk drive, thereby positioning the disk cartridge 21 in the optical disk drive. Both of the recessed gripper slots 26a, 26b and V-groove auto-loading detents 27a, 27b reach the principal surface 22b to make notches on the principal surface 22b but do not reach the principal surface 22a. That is why the recessed gripper slots 26a, 26b and V-groove auto-loading detents 27a, 27b are shown by dotted lines in FIG. 10A.

The lid 24 has a write-protect indicator 28a that shows whether the data storage layer of the optical disk 200 is write enabled or write disabled. The write-protect indicator 28a is a slide switch. By sliding the indicator 28a, a hole can be created or filled in a predetermined region of the cartridge body 22. A sensing mechanism, which is provided for the tray of the optical disk drive (not shown), determines whether the hole is created or filled. If the hole has been created, the optical disk drive determines that writing is prohibited. On the other hand, if the hole has been filled, the optical disk drive determines that writing is permitted.

The lid 24 further includes a lock pin 30a, which fits into the hole 24e of the principal surfaces 22a and 22b, thereby keeping the lid 24 from rotating on the shaft 24a and eventually prohibiting the user from removing the optical disk 200 from the cartridge 21. As shown in FIG. 10B, when the lock pin 30a is unlocked, the lock pin 30a is disengaged from the hole 24e, thus letting the lid 24 rotate freely on the shaft 24a. As a result, the optical disk 200 can be removed through the opening 23d.

The optical disk 200 stored in the disk cartridge 21 shown in FIGS. 10A and 10B has a data storage layer on only one side thereof. In FIGS. 10A and 10B, the data storage layer of the optical disk 200 faces the principal surface 22b. The other side of the optical disk 200 facing the principal surface 22a may have a label printed thereon or may even have a non-recordable information layer (e.g., the innermost lead-in area of the optical disk 200 may have been processed so as to prohibit the user from reading information from that layer).

As described above, neither the gripper slots 26a, 26b nor the auto-loading detents 27a, 27b reach the principal surface 22a (i.e., the principal surface 22a has no openings that communicate with the gripper slots 26a, 26b or the auto-loading detents 27a, 27b). That is why even if the user attempted to load this disk cartridge 21 upside down into an optical disk drive to subject the non-recordable side to a write operation by mistake, the protrusions, which are provided for the tray of the optical disk drive so as to fit into the gripper slots 26a, 26b, would contact with the principal surface 22a, thus blocking the user from loading the disk cartridge 21 upside down by mistake. Also, since the optical disk 200 has a data storage layer on only one side thereof, only one write-protect indicator is provided for the disk cartridge 21.

FIGS. 11A and 11B illustrate a disk cartridge 31 to store an optical disk 300 with data storage layers on both sides. Recently, more and more people tend to record moving picture audio/video signals on optical disks, not videotapes. And as those applications require sufficient storage capacity, there is a growing demand for such double-sided optical disks with two data storage layers.

As shown in FIG. 11A, the disk cartridge 31 includes a cartridge body 32, a shutter 35, and a lid 34. The cartridge body 32 includes a pair of opposed principal surfaces 32a, 32b, a pair of side surfaces 33a, 33b that defines the gap between the principal surfaces 32a, 32b, and another side surface 33c interposed between the side surfaces 33a, 33b. The principal surfaces 32a, 32b and the side surfaces 33a, 33b and 33c define the six sides of a parallel hexahedron. The cartridge body 32 has an opening 33d that is opposed to the side surface 33c. A shaft 33a is arranged near the opening 33d and side surface 33b of the cartridge body 32 and the lid 34 is attached so as to rotate on the shaft 33a.

The principal surfaces 32a, 32b have windows 39 that partially expose the optical disk 300. The shutter 35 includes a pair of main portions to close the windows 39 of the principal surfaces 32a, 32b and a connecting portion to connect the two main portions together. By sliding the connecting portion along the side surface 33c, the main portions open or close the windows 39.

The side surfaces 33a, 33b have recessed gripper slots 36a, 36b near the opening 33d and also have V-groove auto-loading detents 37a, 37b near the side surface 33c. The gripper slots 36a, 36b fit the protrusions of the optical disk drive, thereby positioning the disk cartridge 23 in the optical disk drive. Both of the recessed gripper slots 36a, 36b and V-groove auto-loading detents 37a, 37b reach the principal surfaces 32a, 32b to make notches on the principal surfaces 22a, 22b.

The lid 34 has write-protect indicator 38a, 38b that show whether the data storage layers of the optical disk 300 are write enabled or write disabled. The write-protect indicators 38a, 38b are slide switches. By sliding the indicators 38a, 38b, a hole can be created or filled in a predetermined region of the cartridge body 22. A sensing mechanism, which is provided for the tray of the optical disk drive (not shown), determines whether the hole is created or filled. If the hole has been created, the optical disk drive determines that writing is prohibited. On the other hand, if the hole has been filled, the optical disk drive determines that writing is permitted.

The lid 34 further includes a lock pin 40a, which fits into the hole 34e of the principal surfaces 32a and 32b, thereby keeping the lid 34 from rotating on the shaft 34a and eventually prohibiting the user from removing the optical disk 300 from the cartridge 31. As shown in FIG. 11B, when the lock pin 40a is unlocked, the lock pin 40a is disengaged from the hole 34e, thus letting the lid 34 rotate freely on the shaft 34a. As a result, the optical disk 300 can be removed through the opening 33d.

The optical disk 300 stored in the disk cartridge 31 shown in FIGS. 11A and 11B has data storage layers on both sides thereof. That is why the disk cartridge 31 needs to be loaded into the optical disk drive properly such that either the principal surface 32a or the principal surface 32b is opposed to the optical pickup of the optical disk drive.

For that purpose, both of the gripper slots 36a, 36b and the auto-loading detents 37a, 37b reach the principal surfaces 32a, 32b (i.e., the principal surfaces 22a, 22b have openings that communicate with the gripper slots 36a, 36b and the auto-loading detents 37a, 37b). That is why no matter which side of the disk cartridge 31 is facing the optical pickup, the protrusions always fit into the gripper slots 26a, 26b and the disk cartridge 31 can be loaded into the optical disk drive properly. Also, two write-protect indicators are provided for the disk cartridge 31 as described above.

As can be seen, the conventional disk cartridges for DVD-RAM disks have slightly different shapes, depending on whether the disk stored there has a single data storage layer on only one side thereof or two data storage layers on both sides thereof, so as to be loaded into the optical disk drive properly.

Also, the conventional disk cartridges use write-protect indicator(s) to allow the user to permit or prohibit writing on the data storage layer(s) and remove the optical disk.
Patent Document No. 1: Japanese Patent Application Laid-Open Publication No. 9-045032
Patent Document No. 2: PCT International Application Japanese National Phase Publication No. 2001-513935

### DISCLOSURE OF INVENTION

### PROBLEMS TO BE SOLVED BY THE INVENTION

Recently, as DVD recorders and DVD drives for use as terminal devices for computers have become more and more popular, there is an increasing demand for cheaper rewritable DVD disks (which will be simply referred to herein as “DVD disks”). Meanwhile, the users tend to use selectively either a single-sided rewritable DVD disk or a double-sided rewritable DVD disk depending on the size of the data to be stored, and there is a continuing demand for both of these two types of disks.

However, the disk cartridge 21 for a single-sided rewritable DVD disk and the disk cartridge 31 for a double-sided rewritable DVD disk have mutually different shapes as described above. To manufacture these two types of disk cartridges, two different sets of dies and other manufacturing equipment are needed. Since such manufacturing equipment is expensive, it is currently difficult to cut down the manufacturing costs of rewritable DVD disks. Such a problem arises not just in rewritable optical disks but also in write-once optical disks and even in various other types of data storage media as well.

In order to overcome the problems described above, an object of the present invention is to provide a disk cartridge that can store a single-sided data storage medium and that can be manufactured at a reduced cost.

### MEANS FOR SOLVING THE PROBLEMS

A disk cartridge according to the present invention includes a cartridge body, a shutter, and a lid. The cartridge body includes: first and second principal surfaces that are opposed to each other; a storage space that is provided between the first and second principal surfaces to store a disklike data storage medium therein; windows that are cut through the first and second principal surfaces to partially expose the data storage medium being stored in the storage space; an opening that is located between the first and second principal surfaces such that the data storage medium stored in the storage space is removable from the storage space; and write-protect indicator holes that are provided through the first and second principal surfaces to prohibit writing on the data storage medium stored in the storage space. The shutter is supported movably with respect to the cartridge body so as to open and close the windows of the first and second principal surfaces. The lid is provided to cover and uncover the opening of the cartridge body. The cartridge body is shaped such that both of the first and second principal surfaces are able to be opposed to a pickup of the optical disk drive when the disk cartridge is loaded into the optical disk drive. Of the two write-protect indicator holes that are cut through the first and second principal surfaces, only the hole of the second principal surface is provided with a write enable/disable selecting mechanism that covers or uncovers the write-protect indicator hole.

In one preferred embodiment, the cartridge body further includes: first and second side surfaces, which are adjacent to the opening and opposed to each other; a third side surface, which is adjacent to the first and second side surfaces and opposed to the opening; gripper slot portions, which are cut on the first and second side surfaces near the opening; and auto-loading detents, which are cut on the first and second side surfaces near the third side surface.

In this particular preferred embodiment, the gripper slot portions and the auto-loading detents are both recessed and reach the first and second principal surfaces so as to define notches on the first and second side surfaces.

In another preferred embodiment, the lid is supported near one end thereof so as to be rotatable with respect to the cartridge body.

In still another preferred embodiment, either the lid or the cartridge body has a tab portion that is attached thereto in a removable position, and either the cartridge body or the lid has an engaging portion to engage with the tab portion.

In yet another preferred embodiment, if the cartridge body is arranged vertically such that the third side surface is located over the opening, the second side surface is located on the right-hand side of the first principal surface. The cartridge body has, on the first principal surface, a circular location hole, which has a diameter of 4.00 mm to 4.05 mm and of which the center is set at a distance of 22.8 mm to 23.2 mm from the outside surface of the lid and at a distance of 11.0 mm to 11.4 mm from the second side surface. The write-protect indicator hole has a circular shape, which has a diameter of 3.1 mm to 3.2 mm and of which the center is set at a distance of 18.45 mm to 18.55 mm from the center of the location hole toward the lid and at a distance of 8.95 mm to 9.05 mm from the center of the location hole toward the first side surface.

In yet another preferred embodiment, the disk cartridge further includes a data storage medium, which includes a recordable data storage layer on only one side thereof and which is stored in the storage space of the cartridge body such that the data storage layer faces the second principal surface.

In this particular preferred embodiment, the data storage layer includes a data area, on which user data is written, and a lead-in area, which is located inside of the data area to store information representing where the data belongs.

### EFFECTS OF THE INVENTION

According to the present invention, of the two write-protect indicator holes that are cut through the two principal surfaces of a cartridge body, only the hole of one principal surface is provided with a write enable/disable selecting mechanism that can cover the write-protect indicator hole. That is why before the optical pickup accesses the data recordable side, the optical disk drive can know that no data can be written on the other side of the optical disk, which is opposed to the other principal surface with a write-protect indicator hole that is not provided with the write enable/disable selecting mechanism.

In addition, since the cartridge body is shaped such that both of the two principal surfaces can be opposed to the optical pickup when the disk cartridge is loaded into the optical disk drive, the disk cartridge can be manufactured using the same dies as double-sided disk cartridges. As a result, the manufacturing cost of the disk cartridge can be cut down.

### BRIEF DESCRIPTION OF DRAWINGS

FIG. 1A is a plan view illustrating a preferred embodiment of a disk cartridge according to the present invention.

FIG. 1B is a plan view showing the other side of the disk cartridge shown in FIG. 1A.

FIG. 2 is a plan view showing how the disk cartridge shown in FIG. 1A looks when its lid is opened.

FIG. 3 is a perspective view illustrating the structure of a lock pin, provided for the lid, and its surrounding members.

FIG. 4A shows the write-protect indicator hole 10b and its surrounding members of the plan view shown in FIG. 1A on a larger scale.

FIG. 4B shows the write-protect indicator hole 10c and its surrounding members of the plan view shown in FIG. 1B on a larger scale.

FIG. 5 shows a situation where an optical disk has been stored properly in the disk cartridge shown in FIG. 1A.

FIG. 6 shows a situation where an optical disk has been stored upside down in the disk cartridge shown in FIG. 1A.

FIG. 7 is a plan view illustrating a conventional disk cartridge.

FIG. 8 illustrates the tab portion and its surrounding members of the disk cartridge shown in FIG. 7.

FIGS. 9A, 9B and 9C show how to open the lid of the disk cartridge shown in FIG. 7.

FIG. 10A is a plan view illustrating a conventional single-sided rewritable disk cartridge.

FIG. 10B is a plan view showing how the single-sided rewritable disk cartridge shown in FIG. 10A looks when its lid is opened.

FIG. 11A is a plan view illustrating a conventional double-sided rewritable disk cartridge.

FIG. 11B is a plan view showing how the double-sided rewritable disk cartridge shown in FIG. 11A looks when its lid is opened.

### DESCRIPTION OF REFERENCE NUMERALS

1 disk cartridge
2 cartridge body
4 lid
4b lock pin
5 shutter
6a, 6b gripper slot
7a, 7b auto-loading detent
8a, 8c alignment hole
8b, 8d location hole
10a write enable/disable selecting mechanism
10c write-protect indicator hole
13 window
400 optical disk

### MODE FOR CARRYING OUT THE INVENTION

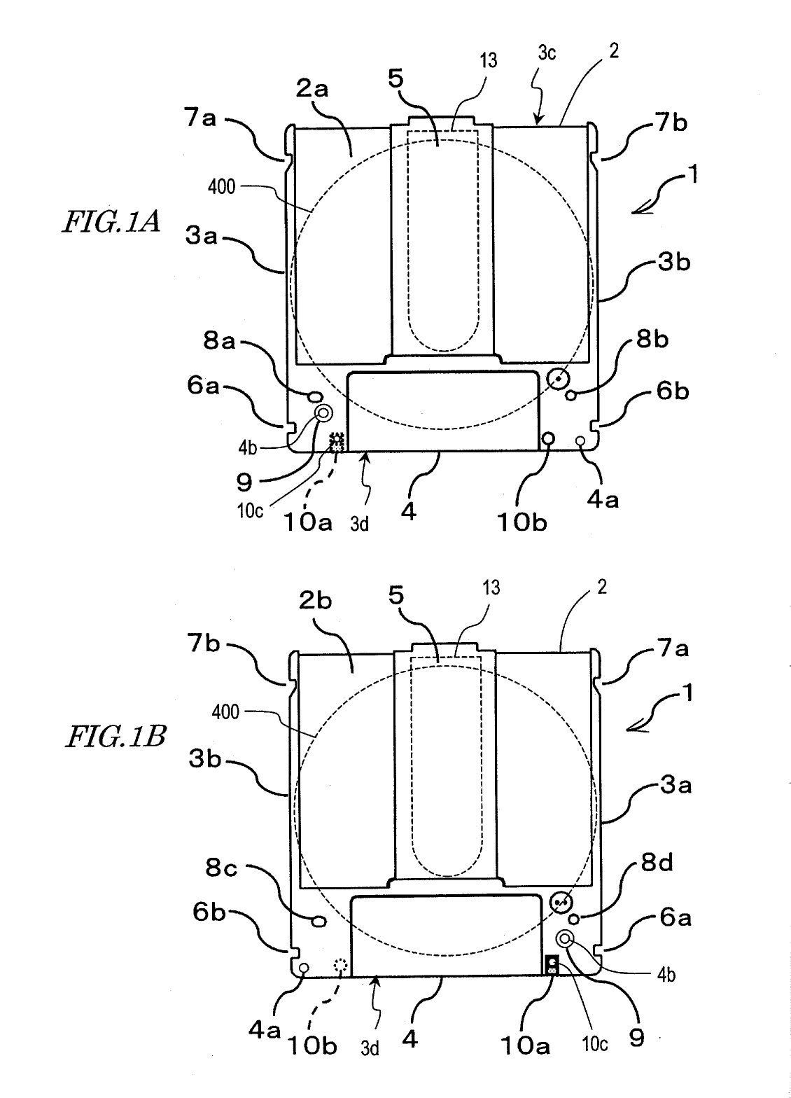

Hereinafter, preferred embodiments of a disk cartridge according to the present invention will be described with reference to the accompanying drawings. FIGS. 1A and 1B are plan views illustrating the structure of a disk cartridge 1. Specifically, FIG. 1A is a plan view illustrating the disk cartridge 1 with the first side of the disk (which is usually called “side A”) faced down. FIG. 1B is a plan view illustrating the disk cartridge 1 with the second side of the disk (which is usually called “side B”) faced down. The disk cartridge 1 stores a disklike data storage medium 400, only one side of which includes a rewritable storage layer. In the following description, the data storage medium 400 is supposed to be an optical disk. However, the disk cartridge of the present invention can be used effectively not only in optical disks but also in magneto-optical disks and other types of data storage media as well. Also, in the following example, the data storage medium is supposed to be a rewritable optical disk. Alternatively, any other recordable data storage medium such as a write-once disk may also be used.

Usually, if an optical disk drive is loaded horizontally with either an optical disk or a disk cartridge storing an optical disk, then the optical pickup accesses the lower side (i.e., back surface) of the disk to read and write data from/on the disk. However, when the user picks and looks at the optical disk or the disk cartridge, the lower side (back surface) does not face the user and is invisible to him or her. That is why the label such as “Side A” or “Side B” to recognize the sides of the disk is printed on the opposite side of the disk. For example, if the user picks an optical disk or a disk cartridge and loads it into an optical disk drive with “Side A” shown on the upside, then read/write operations are performed on the other side of the disk, which is opposite to Side A.

The disk cartridge 1 includes a cartridge body 2, a lid 4 and a shutter 5. The cartridge body 2 has first and second principal surfaces 2a, 2b that are opposed to each other, first and second side surfaces 3a, 3b that are also opposed to each other, and a third side surface 3c. The first, second and third side surfaces 3a, 3b and 3c define the gap between the first and second principal surfaces 2a, 2b and form a storage space to store the optical disk 400 along with the first and second principal surfaces 2a, 2b. An opening 3d is provided between the first and second principal surfaces 2a, 2b so as to be opposed to the side surface 3c. The size and shape of the opening 3d are defined such that the optical disk 400 can be easily removed from the storage space.

The first and second principal surfaces 2a and 2b have windows 13 that partially expose the optical disk 400 in the storage space, and also have write-protect indicator holes 10b and 10e, respectively, showing that writing on the optical disk 400 is prohibited.

The first and second side surfaces 3a and 3b have auto-loading detents 7a, 7b, respectively, near the third side surface 3c. The auto-loading detents 7a, 7b have a recessed shape with a sloped side closer to the opening 3d. The first and second side surfaces 3a and 3b also have gripper slots 6a, 6b closer to the opening 3d. The gripper slots 6a, 6b have an indented shape with a rectangular cross section. As shown in FIGS. 1A and 1B, the auto-loading detents 7a, 7b and gripper slots 6a, 6b reach the first and second principal surfaces 2a and 2b to define notches with respective cross sections on the first and second principal surfaces 2a and 2b. That is why protrusions provided for the optical disk drive can be inserted vertically into the auto-loading detents 7a, 7b and gripper slots 6a, 6b from over or under either the first principal surface 2a or the second principal surface 2b. Consequently, the cartridge body 2 is shaped such that both of the first and second principal surfaces 2a, 2b can be opposed to the pickup of the optical disk drive when the disk cartridge is loaded into the optical disk drive.

The first and second principal surfaces 2a and 2b have windows 13 that partially expose the optical disk 400 to let the optical head access the optical disk and perform read/write operations on it.

The shutter 5 is supported movably with respect to the cartridge body 2 so as to open and close the windows 13 of the first and second principal surfaces 2a and 2b. More specifically, the shutter 5 includes a pair of main portions to shut the windows 13 of the first and second principal surfaces 2a, 2b and a connecting portion to connect the two main portions together. The connecting portion is attached to the third side surface 3c so as to slide along the third side surface 3c toward either the first side surface 3a or the second side surface 3b. That is why no matter whether the first principal surface 2a or the second principal surface 2b is opposed to the pickup of the optical disk drive while the disk cartridge is being loaded into the optical disk drive, one of the windows 13 can always be opened by sliding the shutter in either direction in the optical disk drive.

The first and second principal surfaces 2a and 2b of the cartridge body 2 have holes 8a, 8b, 8c and 8d to receive alignment pins for use to position the disk cartridge 1 in the optical disk drive. More specifically, the first and second principal surfaces 2a and 2b have elliptical alignment holes 8a, 8c that are elongated perpendicularly to the first and second side surfaces 3a and 3b. The first and second principal surfaces 2a and 2b also have circular location holes 8b, 8d. The alignment hole 8a and the location hole 8d are located close to the first side surface 3a, while the alignment hole 8c and the location hole 8b are located close to the second side surface 3b. The alignment holes 8a, 8c and location holes 8b, 8d may be either through holes or non-through holes with a predetermined depth (of 1.2 mm or more, for example), which is deep enough to receive the alignment pins firmly.

As will be described in detail later, the first principal surface 2a of the cartridge body 2 has write-protect indicator holes 10b, 10c. If the write-protect indicator holes 10b and 10c are opened, the optical disk drive senses the opened state of the write-protect indicator holes 10b and 10c using a sensing section thereof. Based on the sensing result, the optical disk drive is set so as not to write on the optical disk 400 in the disk cartridge 1.

As will also be described in detail later, of the two write-protect indicator holes 10b, 10c, only the write-protect indicator hole 10c is provided with a write enable/disable selecting mechanism 10a that covers or uncovers the write-protect indicator hole 10c.

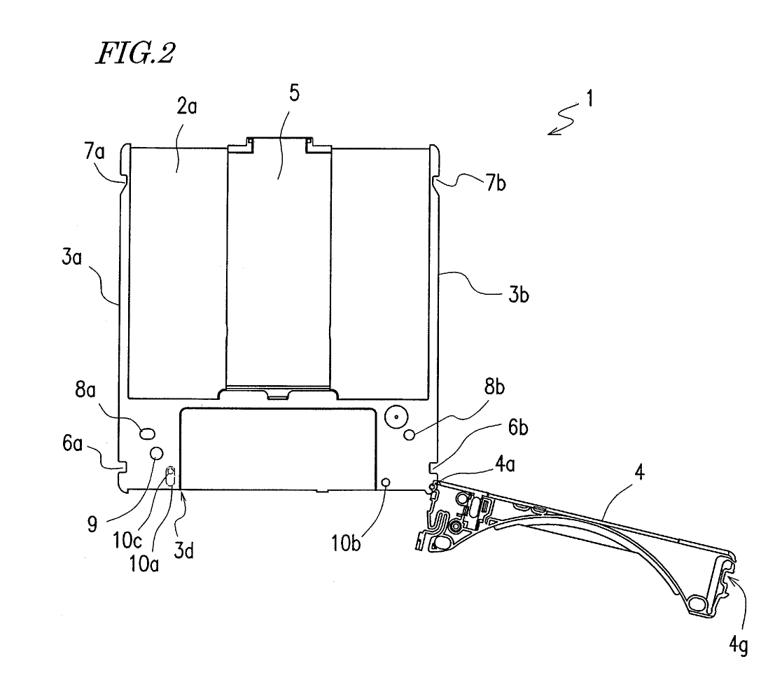

The lid 4 covers and uncovers the opening 3d of the cartridge body 2. FIG. 2 shows a situation where the lid 4 has uncovered the opening 3d. The lid 4 is attached to the cartridge body 2 so as to turn on the shaft 4a, which is arranged near the opening 3d and second side surface 3b of the cartridge body 2. As shown in FIG. 2, an engaging portion 4g arranged at the other end of the lid 4, which is opposite the one end with the shaft 4a, so as to engage with the cartridge body 2 when the opening 3d is covered.

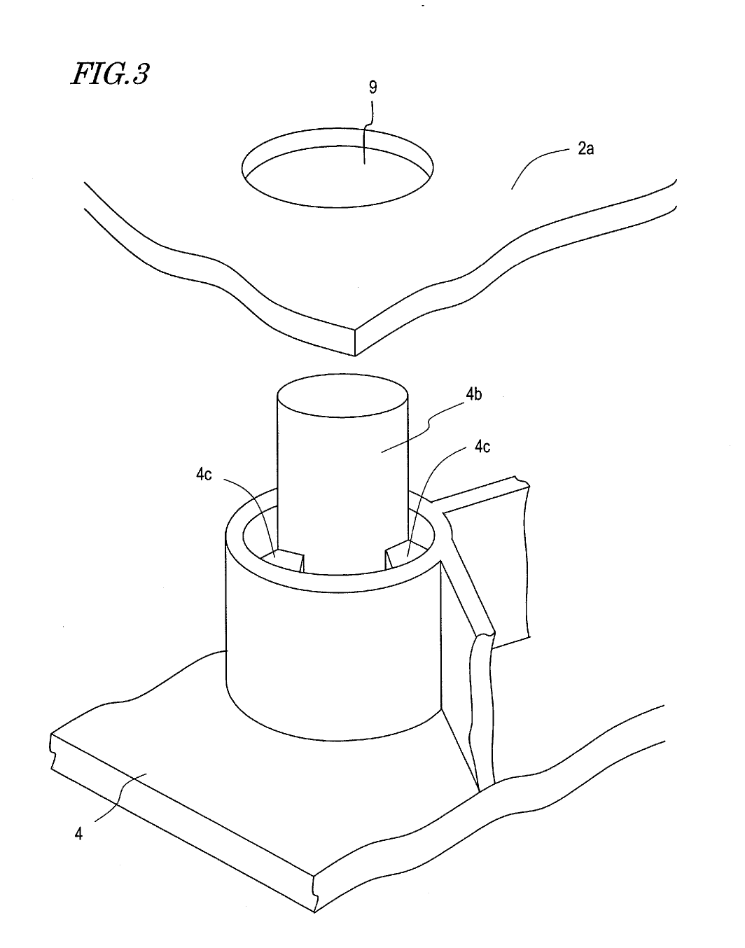

If the lid 4 has ever been opened at least once, the optical disk 400 may have been removed from the disk cartridge 1. That is why a tab showing whether or not the lid 4 has ever been opened is provided for the disk cartridge 1. In this preferred embodiment, the tab is a lock pin 4b, which is attached in a removable position to the lid 4. FIG. 3 illustrates the lock pin 4b provided for the lid 4 and its surrounding members on a larger scale. As shown in FIG. 3, the lock pin 4b is attached to the lid 4 with a number of thin connectors 4c. The first principal surface 2a of the cartridge body 2 has a hole 9 that receives the lock pin 4b. If the lid 4 has never been opened, the lock pin 4b is inserted into the hole 9 so as to fill the hole 9 at least partially.

Although not shown in FIG. 3, the lock pin 4b actually extends through the second principal surface 2b and is inserted into the hole 9 of the second principal surface 2b to fill the hole 9 partially as shown in FIG. 1B. That is why if the lid 4 has never been opened, the holes 9 of the first and second principal surfaces 2a and 2b should be closed with the lock pin 4b. That is to say, the holes 9 tell the removal history.

To remove the optical disk 400 from the disk cartridge 1 by turning the lid 4, the lock pin 4b may be pressed with something with a sharp end such as a ballpoint pen. Then, the connectors 4c will be broken and the lock pin 4b will be cut off the lid 4. At the same time, the lock pin 4b will also be disengaged from the holes 9 of the first and second principal surfaces 2a and 2b. If the lid 4 is turned with the engaging portion 4g pressed, the opening 3d is uncovered. Once the lock pin 4b has been cut off the lid 4, the holes 9 of the first and second principal surfaces 2a and 2b of the disk cartridge 1 remain opened. That is why when loaded with the disk cartridge 1, the optical disk drive sees if the holes 9 are opened and determines what to do based on the sensing result. For example, if the optical disk drive has sensed the holes 9 are opened, the optical disk 400 may have been removed once, and therefore, the optical disk 400 is checked for defects before subjected to a write operation.

In this preferred embodiment, the lock pin 4b as a tab is provided for the lid 4. Alternatively, the lock pin may be attached removably to the cartridge body 2 with connectors so as to partially close the holes 9 of the first and second principal surfaces 2a and 2b. In that case, an engaging portion such as a through hole is provided for the lid 4 so as to receive the lock pin attached to the cartridge body 2.

Also, in the preferred embodiment described above, the lid 4 has a structure that is supported to the cartridge body 2 so as to turn on the shaft 4a. However, the lid 4 may have any other structure as long as the lid 4 can cover and uncover the opening 3d. For example, the lid 4 may have a pair of cuplike holding portions and have such a structure that holds the optical disk 300 between the cuplike holding portions when the lid 4 is pulled off the cartridge body 2. Alternatively, as disclosed in Patent Document No. 2, the lid 4 may have a structure that opens along with a shutter.

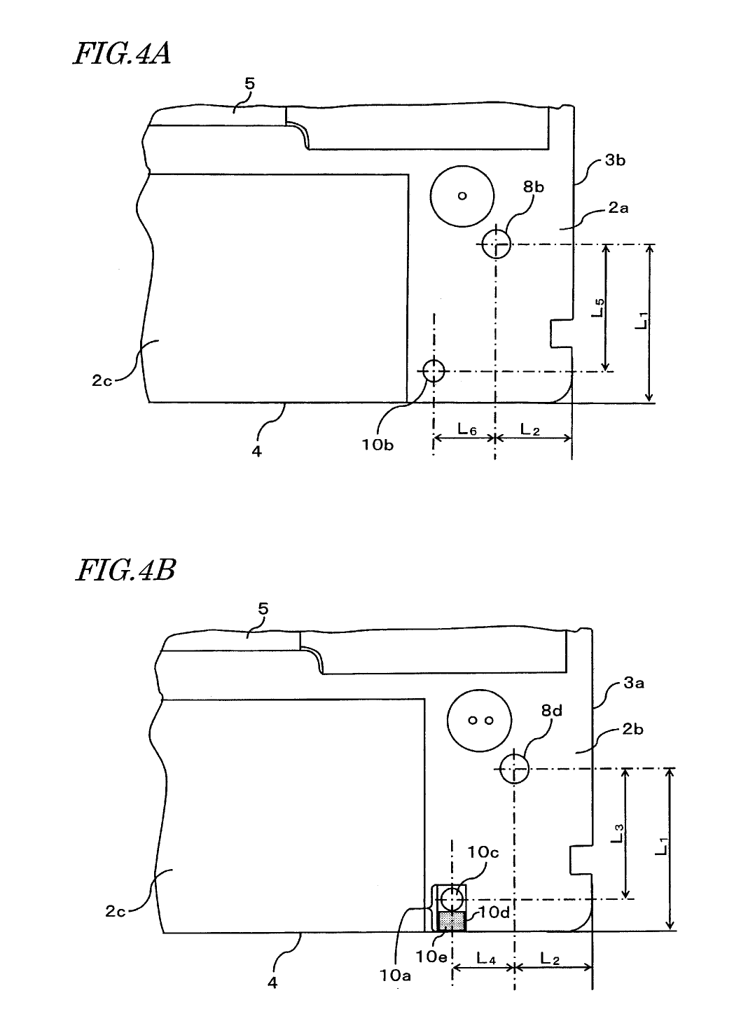

Next, the write-protect indicator holes 10b, 10c will be described in detail. FIG. 4A illustrates the structures of the write-protect indicator hole 10b and its surrounding members on the first principal surface 2a. FIG. 4B illustrates the structure of the write-protect indicator hole 10c with the write enable/disable selecting mechanism 10a and their surrounding members on the second principal surface 2b. As in FIGS. 1A and 1B, these drawings are illustrated with the third side surface 3c and opening 3d located at the top and the bottom of the drawings.

As described above, when the optical disk drive is horizontally loaded with a disk cartridge that stores an optical disk therein, the optical pickup accesses the lower side (i.e., back surface) of the disk cartridge to read and write data from/on the disk. At this time, the optical disk drive senses whether the alignment hole, location hole, write-protect indicator hole and hole showing the removal history on the lower side are opened or closed. That is why the write-protect indicator hole 10b is used to prohibit writing on one storage layer of the optical disk that faces the first principal surface 2a. In the same way, the write-protect indicator hole 10c is used to prohibit writing on the other storage layer of the optical disk that faces the second principal surface 2b.

As shown in FIGS. 4A and 4B, the write enable/disable selecting mechanism 10a is provided for the write-protect indicator hole 10c on the second principal surface 2b but no write enable/disable selecting mechanism 10a is provided for the write-protect indicator hole 10b on the first principal surface 2a. That is why the user cannot cover the write-protect indicator hole 10b on the first principal surface 2a. That is to say, writing on that side of the optical disk 400, facing the first principal surface 2a of the disk cartridge 1, is always prohibited.

On the other hand, the write-protect indicator hole 10c on the second principal surface 2b is provided with the write enable/disable selecting mechanism 10a. In this preferred embodiment, the write enable/disable selecting mechanism 10a includes a groove 10d, which is cut on the second principal surface 2b, and a slider 10e, which is arranged movably along the groove 10d. The groove 10d is a recess on the second principal surface 2b and the write-protect indicator hole 10c is located at the bottom of the groove 10d. The slider 10e arranged in the groove 10d has its upper surface almost leveled with the second principal surface 2b.

In this preferred embodiment, the write enable/disable selecting mechanism 10a is provided for the cartridge body 2. However, the write enable/disable selecting mechanism 10a may also be provided for the lid 4 as long as the mechanism 10a can cover and uncover the write-protect indicator hole 10c. Also, the write enable/disable selecting mechanism does not have to have the slider and groove combination but may have any other structure.

FIG. 4B illustrates a situation where the write-protect indicator hole 10c has been uncovered. If the disk cartridge 1 in such a state is loaded into the optical disk drive, the optical disk drive senses the write-protect indicator hole 10c open. Then, the optical disk drive prohibits writing on that side of the optical disk 400 facing the second principal surface 2b of the disk cartridge 1.

The user can cover the write-protect indicator hole 10c by turning the slider 10e. If the disk cartridge 1 in such a state is loaded into the optical disk drive, the optical disk drive senses the write-protect indicator hole 10c closed. Then, the optical disk drive permits writing on that side of the optical disk 400 facing the second principal surface 2b of the disk cartridge 1. In this manner, the user can selectively enable or disable the drive to write on that side of the optical disk 400 facing the second principal surface 2b of the disk cartridge 1 by using the write enable/disable selecting mechanism 10a.

The disk cartridge 1 is positioned in the optical disk drive with reference to the location holes 8b, 8d and the alignment holes 8a, 8c. That is why the write-protect indicator holes 10b and 10c are also preferably located with reference to these holes (among other things, with respect to the location holes 8b and 8d that are close to the write-protect indicator hole 10b, 10c). If the optical disk 400 is a DVD-RAM, the locations of the location holes 8b and 8d are defined by JIS standard X6244. More specifically, supposing the distance from the outside surface of the lid 4 to the center of the location hole 8b is L₁ and the distance from the second side surface 3b to the center of the location hole 8b is L₂, L₁ and L₂ preferably satisfy 22.8 mm≦L₁≦23.2 mm and 11.0 mm≦L₂≦11.4 mm and the diameter R₁ of the location hole 8b preferably satisfies 4.00 mm≦R₁≦4.05 mm.

The center of the write-protect indicator hole 10b is located at a distance L₅ from the center of the location hole 8b toward the lid 4 and at a distance L₆ from the center of the location hole 8b toward the first side surface 3a (see FIG. 1A). L₅ and L₆ preferably satisfy 18.45 mm≦L₅≦18.55 mm and 8.95 mm≦L₆≦9.05 mm, respectively, the diameter R₂ of the write-protect indicator hole 10b preferably satisfies 3.1 mm≦R₂≦3.2 mm and the depth D₁ of the hole 10b preferably satisfies 5.0 mm≦D₁.

On the other hand, the center of the location hole 8d is located at the distance L₁ from the outside surface of the lid 4 and at the distance L₂ from the second side surface 3b as shown in FIG. 4B.

The center of the write-protect indicator hole 10c is located at a distance L₃ from the center of the location hole 8c toward the lid 4 and at a distance L₄ from the center of the location hole 8d toward the second side surface 3b (see FIG. 1B). L₃ and L₄ preferably satisfy 18.3 mm≦L₃≦18.7 mm and 8.8 mm≦L₄≦9.2 mm, respectively, the radius R₃ of the write-protect indicator hole 10c preferably satisfies 3.00 mm≦R₃ and the depth D₂ of the hole 10c preferably satisfies 5.0 mm≦D₂.

The write-protect indicator hole 10b needs to be detected by the detecting section of the optical disk drive to prohibit writing on that side of the optical disk 400 facing the first principal surface 2a of the disk cartridge 1 without fail. For that purpose, the tolerance of the center of the write-protect indicator hole 10b is set stricter than that of the write-protect indicator hole 10c. In addition, by setting the tolerance of the diameter of the write-protect indicator hole 10b greater than the minimum value of the diameter of the write-protect indicator hole 10c and by decreasing the maximum value of the tolerance, it is possible to prevent the optical disk drive from detecting the write-protect indicator hole 10b by mistake. By setting the location and size of the write-protect indicator hole 10b within the range described above, the probability of erroneous detection can be reduced and it is possible to prohibit the optical disk drive from writing on that side of the optical disk 400 facing the first principal surface 2a of the disk cartridge 1.

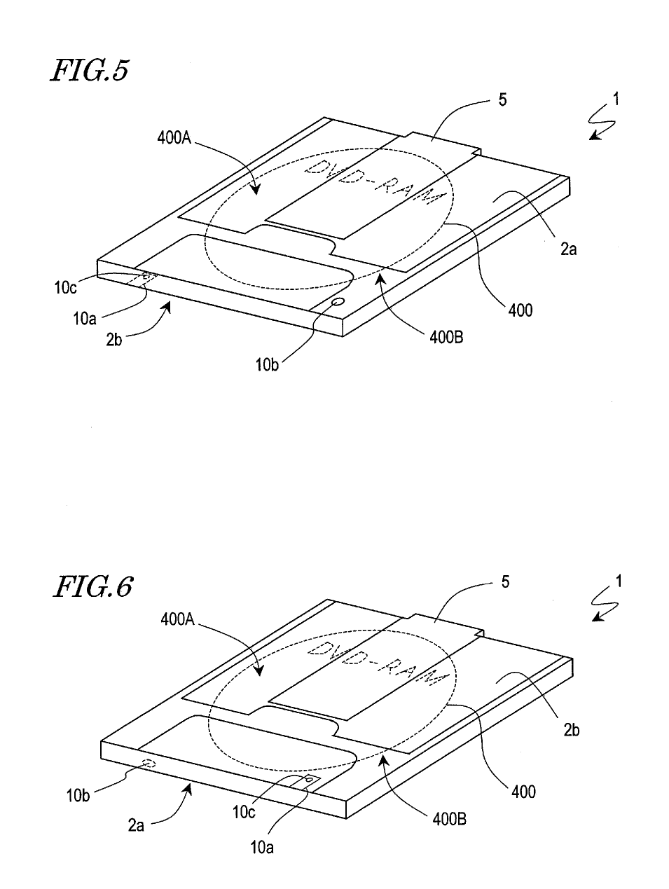

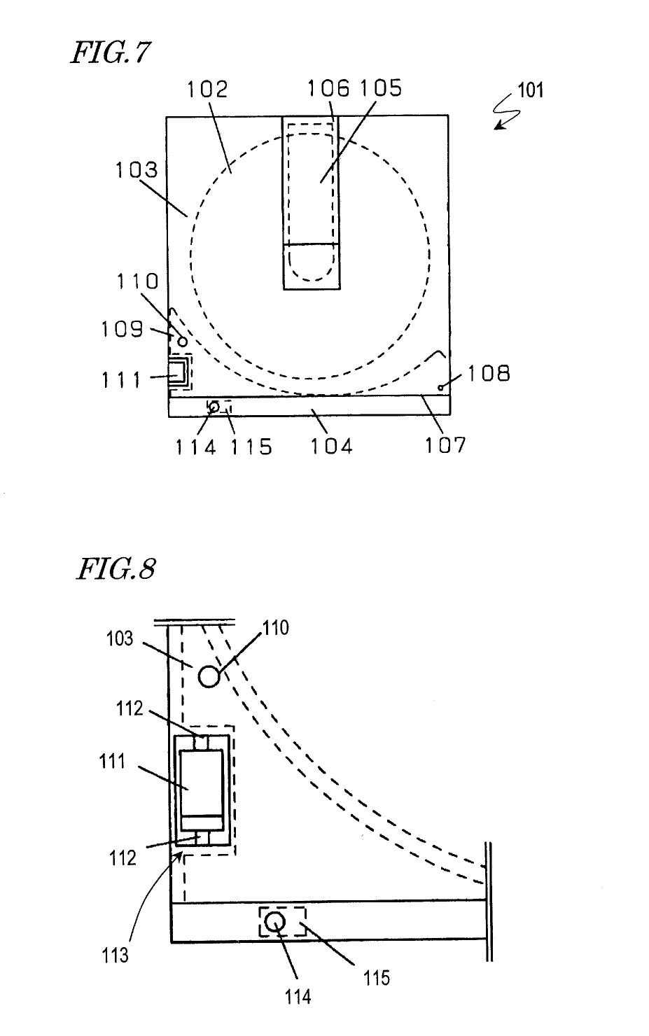

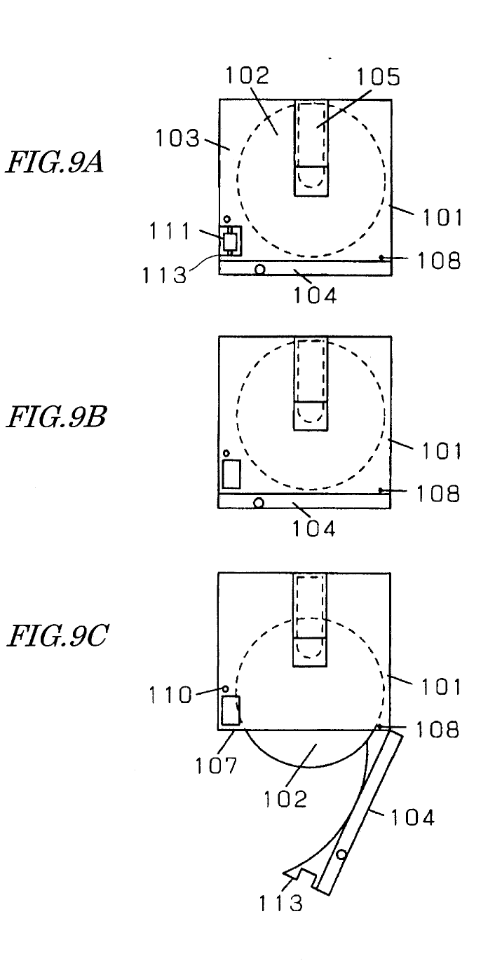

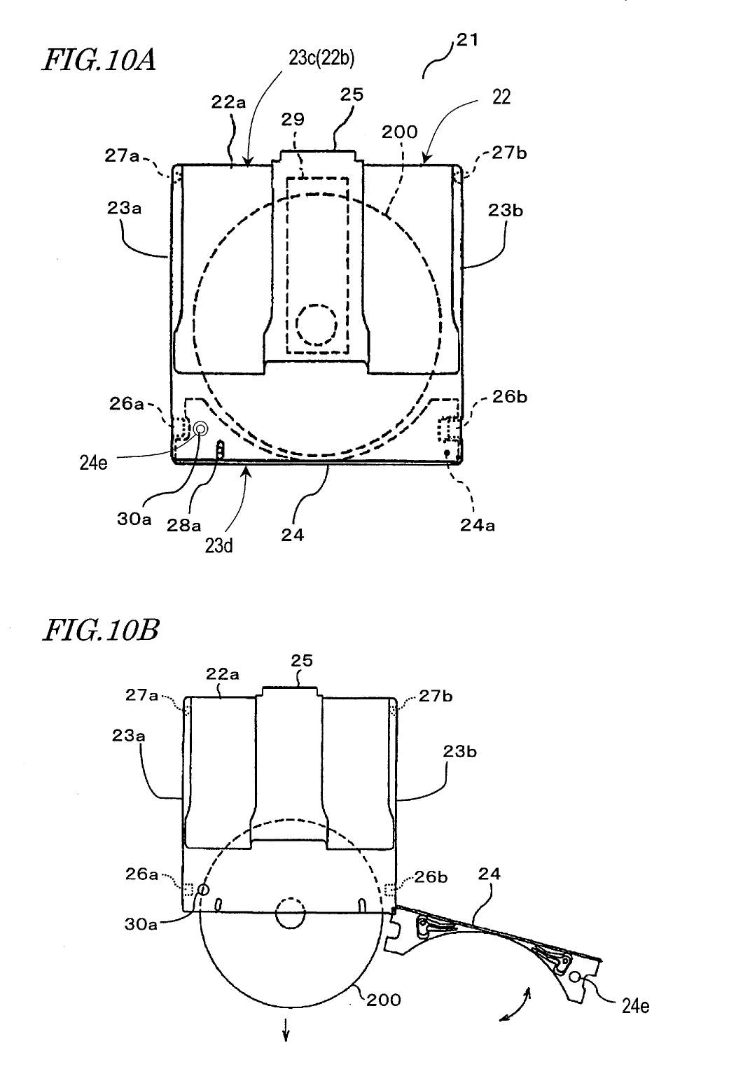

Next, it will be described with reference to FIGS. 5 and 6 how to write data to the disk cartridge 1. As shown in FIG. 5, the optical disk 400 is a single-sided rewritable type and has a data recordable side 400B and a non-recordable side 400A on which no data can be written. The non-recordable side 400A may either be a label side on which the storage capacity or the disk type of the optical disk 400 is printed (e.g., a label side on which a DVD-RAM logo is printed as a disk type in FIG. 5) or have a data storage layer on which no data can be written. The data recordable side 400B has a rewritable data storage layer, which includes a data area where user data can be written and a lead-in area, located inside of the data area, to store information representing where the data belongs.

The non-recordable side 400A of the optical disk 400 faces the first principal surface 2a with the write-protect indicator hole 10b, while the data recordable side 400B faces the second principal surface 2b with the write-protect indicator hole 10c, which is provided with the write enable/disable selecting mechanism 10a. The disk cartridge 1 stores the optical disk 400 in such a state with the hole 9 filled with the lock pin 4b as shown in FIGS. 1A and 1B. The user may cover or uncover the write-protect indicator hole 10c using the write enable/disable selecting mechanism 10a.

If the disk cartridge 1 is loaded into the optical disk drive with the first principal surface 2a and the non-recordable side 400A facing upward and with the second principal surface 2b and the data recordable side 400B facing the optical pickup as shown in FIG. 5, the optical disk drive senses whether the write-protect indicator hole 10c on the second principal surface 2b is opened or closed. And based on the sensing result, the optical disk drive may permit or prohibit writing on the data recordable side 400B. More particularly, if the user has opened the write-protect indicator hole 10c using the write enable/disable selecting mechanism 10a, writing is prohibited. On the other hand, if he or she has closed the write-protect indicator hole 10c using the write enable/disable selecting mechanism 10a, writing is permitted.

As already described with reference to FIGS. 1A and 1B, the cartridge body 2 is shaped such that both of the first and second principal surfaces 2a and 2b can be opposed to the pickup of the optical disk drive when the disk cartridge is loaded into the optical disk drive. That is why the disk cartridge 1 may be loaded into the optical disk drive with the second principal surface 2b and the data-recordable side 400B facing upward and with the first principal surface 2a and the non-recordable side 400A facing the optical pickup contrary to the disk cartridge 1 shown in FIG. 5. In that case, the optical disk drive senses the write-protect indicator hole 10c on the second principal surface 2b opened, thus prohibiting writing on the non-recordable side 400A. The status of the write-protect indicator hole 10c is not sensed at least until the disk cartridge 1 has been loaded into the optical disk drive completely. Thus, after having been loaded with the disk cartridge 1, the optical disk drive may alert the user to the fact that writing is prohibited. That is to say, the user can be alerted before the optical pickup actually accesses the non-recordable side 400A. As a result, he or she can notice that the disk cartridge 1 has been loaded upside down just after the disk cartridge 1 has been inserted.

Suppose the user removes the optical disk 400 once by cutting off the lock pin 4b (see FIGS. 1A and 3) and opening the lid 4 and then stores the optical disk 400 back into the disk cartridge 1 again as shown in FIG. 5. In that case, the non-recordable side 400A of the optical disk 400 faces the first principal surface 2a with the write-protect indicator hole 10b, while the data recordable side 400B thereof faces the second principal surface 2b with the write-protect indicator hole 10c. That is to say, the status of the disk cartridge 1 remains the same as that described above except that the lock pin 4b has been cut off and the removal history hole 9 (see FIGS. 1A and 1B) is opened. Thus, the optical disk drive 1 senses the removal history hole 9 opened and then does a defect test, if necessary, before starting to operate as described above.

Suppose the user removes the optical disk 1 once by cutting off the lock pin 4b and opening the lid 4 and then inserts the optical disk 400 upside down into the disk cartridge 1 again. In that case, the non-recordable side 400A of the optical disk 400 faces the first principal surface 2a with the write-protect indicator hole 10c, while the data recordable side 400B thereof faces the second principal surface 2b with the write-protect indicator hole 10c as shown in FIG. 6.

If the disk cartridge 1 including the optical disk 400 has been loaded into the optical disk drive with the second surface 2b facing upward and with the first surface 2a facing the optical pickup as shown in FIG. 6, the optical disk drive senses the write-protect indicator hole 10b on the first principal surface 2a opened, thus prohibiting writing on the non-recordable side 400A. As the data-recordable side 400B faces the first surface 2a, the optical disk drive can read data from the data-recordable side 400B on receiving a read instruction from the user.

These two directions the disk cartridge 1 and the optical disk 400 face in this case are an inappropriate combination. However, it is not unthinkable that the user inserts the optical disk 400 in such a combination of directions by mistake. Also, since the first principal surface 2a of the disk cartridge 1 in which a single-sided rewritable optical disk is stored is not used normally, the user may insert the optical disk 400 in such a combination of directions intentionally to prohibit writing on the disk.

In any case, when the disk cartridge is used inappropriately that way, it is most important to prevent the data that has already been stored in the data-recordable side 400B from being altered by mistake. In the disk cartridge 1 of this preferred embodiment, the write-protect indicator hole 10b on the first principal surface 2a is not provided with the write enable/disable selecting mechanism 10a, and therefore, the user cannot cover the write-protect indicator hole 10b. That is why even when the disk cartridge is used in such a wrong way, writing on the data-recordable side 400B is still prohibited. As a result, the data that has been written by the user is never erased by mistake.

Also, suppose the disk cartridge 1 in which the optical disk 400 is stored as shown in FIG. 6 is loaded into the optical disk drive with the second principal surface 2b facing the optical pickup. In that case, the optical disk drive senses whether the write-protect indicator hole 10c is opened or closed before starting a write operation. However, as the non-recordable side 400A faces the optical pickup, actually no data can be written on that side.

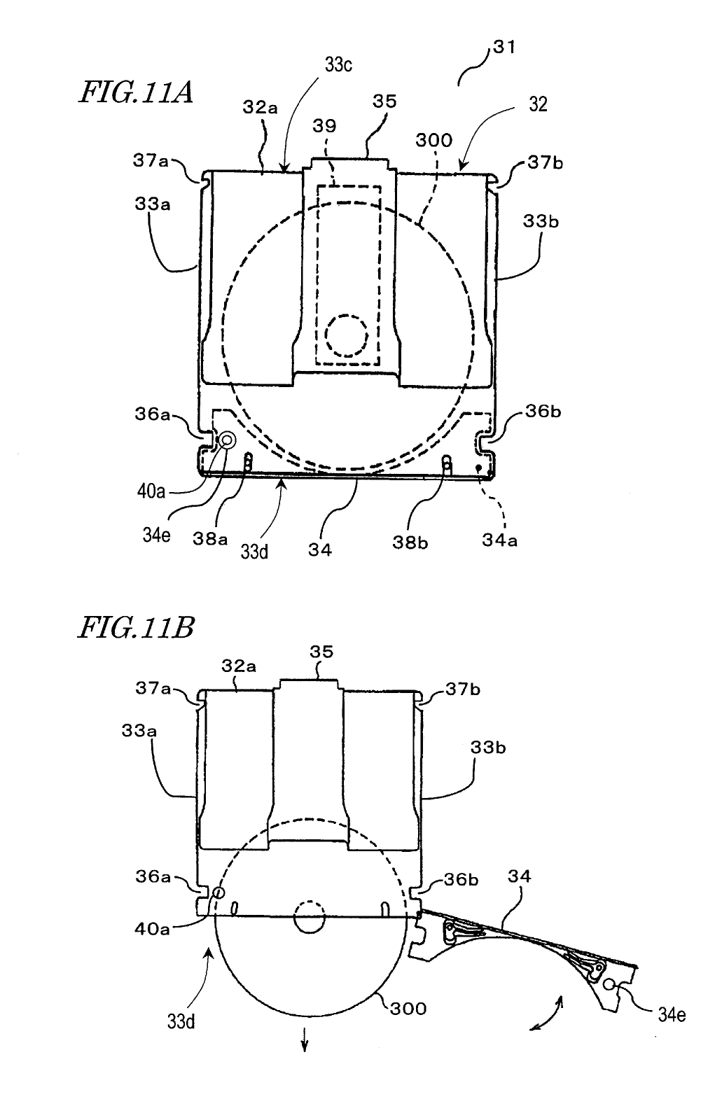

The disk cartridge 1 of the present invention may be made of a polycarbonate resin, an ABS resin, a polystyrene resin or any other suitable material by an injection molding process. As described above, the disk cartridge 1 is shaped so as to be loadable into the optical disk drive with any of the two sides faced upward. That is to say, the disk cartridge 1 of the present invention has almost the same shape as the double-sided rewritable disk cartridge shown in FIGS. 11A and 11B except the structure near the write-protect indicator holes 10b and 10c. For that reason, if a set of dies with a nesting structure for forming the structure near the write-protect indicator holes 10b and 10c is used, the disk cartridge 1 of the present invention of the single-sided rewritable type can be made with the same dies as the double-sided rewritable type of disk cartridge shown in FIGS. 11A and 11B. Consequently, the disk cartridges 1 of the single-sided rewritable type and the disk cartridges 31 of the double-sided rewritable type can be manufactured without changing the whole sets of dies and the manufacturing process can be finished in a shorter time. On top of that, since there is no need to prepare dedicated sets of dies for the disk cartridges 1 of the single-sided rewritable type and the disk cartridges 31 of the double-sided rewritable type, the die set cost can be reduced and the overall manufacturing costs of the disk cartridges of the single-sided rewritable type can be cut down, too.

In the disk cartridge of the preferred embodiment described above, of the two write-protect indicator holes that are cut through the two principal surfaces of the cartridge body, only the hole on one principal surface is provided with a write enable/disable selecting mechanism. That is why if a single-side rewritable optical disk with a non-recordable side is stored in a disk cartridge such that the non-recordable side faces the principal surface with a write-protect indicator hole without the write enable/disable selecting mechanism, the optical disk drive can sense the write-protect indicator hole opened and also sense that this is a non-recordable side before the optical pickup actually accesses that non-recordable side.

Besides, as one of the two write-protect indicator holes has no write enable/disable selecting mechanism, writing on the data-recordable side of an optical disk is prohibited even if the user has removed the optical disk from the disk cartridge once and then inserted the disk into the disk cartridge again upside down. As a result, the data that has been written on the data-recordable side is never altered by mistake.

What is more, in the disk cartridge of the preferred embodiment described above, the cartridge body is shaped so as to be loadable into the optical disk drive with any of the two sides faced upward. For that reason, the disk cartridges of the preferred embodiment described above can be manufactured using the same die set as disk cartridges to store a double-sided rewritable disk. Consequently, the overall manufacturing costs of disk cartridges can be cut down.

The disk cartridge is supposed to store a rewritable data storage medium in the preferred embodiments described above but may also store a write-once data storage medium. In the latter case, even if the disk has been inserted into the disk cartridge upside down, it is also possible to prevent the optical disk drive from adding unwanted data for the user or erasing data by mistake.

### INDUSTRIAL APPLICABILITY

The disk cartridge of the present invention can be used effectively to store a data storage medium with a single data storage layer and is preferably used for a single-sided rewritable optical disk, from/on which data is read and written optically, among other things.

1. A disk cartridge comprising
a cartridge body including: first and second principal surfaces that are opposed to each other; a storage space that is provided between the first and second principal surfaces to store a disklike data storage medium therein; windows that are provided through the first and second principal surfaces to partially expose the data storage medium being stored in the storage space; an opening that is located between the first and second principal surfaces such that the data storage medium stored in the storage space is removable from the storage space; and write-protect indicator holes that are provided through the first and second principal surfaces to prohibit writing on the data storage medium stored in the storage space,
a shutter that is supported movably with respect to the cartridge body so as to open and close the windows of the first and second principal surfaces, and
a lid to cover and uncover the opening of the cartridge body,
wherein the cartridge body is shaped such that both of the first and second principal surfaces are able to be opposed to a pickup of the optical disk drive when the disk cartridge is loaded into the optical disk drive, and
wherein of the two write-protect indicator holes that are provided through the first and second principal surfaces, only the hole of the second principal surface is provided with a write enable/disable selecting mechanism that covers or uncovers the write-protect indicator hole.

2. The disk cartridge of claim 1, wherein the cartridge body further includes:
first and second side surfaces, which are adjacent to the opening and opposed to each other;
a third side surface, which is adjacent to the first and second side surfaces and opposed to the opening;
gripper slot portions, which are cut on the first and second side surfaces near the opening; and
auto-loading detents, which are cut on the first and second side surfaces near the third side surface.

3. The disk cartridge of claim 2, wherein the gripper slot portions and the auto-loading detents are both recessed and reach the first and second principal surfaces so as to define notches on the first and second side surfaces.

4. The disk cartridge of claim 1, wherein the lid is supported near one end thereof so as to be rotatable with respect to the cartridge body.

5. The disk cartridge of claim 1, wherein either the lid or the cartridge body has a tab portion that is attached thereto in a removable position, and
wherein either the cartridge body or the lid has an engaging portion to engage with the tab portion.

6. The disk cartridge of claim 1, wherein if the cartridge body is arranged vertically such that the third side surface is located over the opening, the second side surface is located on the right-hand side of the first principal surface, and
wherein the cartridge body has, on the first principal surface, a circular location hole, which has a diameter of 4.00 mm to 4.05 mm and of which the center is set at a distance of 22.8 mm to 23.2 mm from the outside surface of the lid and at a distance of 11.0 mm to 11.4 mm from the second side surface, and
wherein the write-protect indicator hole has a circular shape, which has a diameter of 3.1 mm to 3.2 mm and of which the center is set at a distance of 18.45 mm to 18.55 mm from the center of the location hole toward the lid and at a distance of 8.95 mm to 9.05 mm from the center of the location hole toward the first side surface.

7. The disk cartridge of claim 1, further comprising a data storage medium,
wherein the data storage medium includes a recordable data storage layer on only one side thereof and is stored in the storage space of the cartridge body such that the data storage layer faces the second principal surface.

8. The disk cartridge of claim 7, wherein the data storage layer includes a data area, on which user data is written, and a lead-in area, which is located inside of the data area to store information representing where the data belongs.
